(19) United States
(12) Patent Application Publication
(10) Pub. No.: US 2011/0309106 A1
(43) Pub. Date: Dec. 22, 2011

(54) APPARATUS AND METHODS FOR PORTIONING AND DISPENSING A FROZEN PRODUCT

(76) Inventor: David B. Anderson, St. George, UT (US)

(21) Appl. No.: 13/187,363

(22) Filed: Jul. 20, 2011

Related U.S. Application Data
(63) Continuation of application No. 12/401,119, filed on Mar. 10, 2009, now abandoned.
(60) Provisional application No. 61/035,336, filed on Mar. 10, 2008.

(51) Int. Cl. B67D 7/06

(52) U.S. Cl. 222/129

(57) ABSTRACT

Apparatus and methods are disclosed for portioning and dispensing a frozen product. The apparatus may comprise a storage container for the frozen product and, in some embodiments, multiple storage containers for storing a plurality of different frozen products. A portion of the frozen product in the storage container may be transferred to a portioning container by movement means, such as a belt drive. The portion may be separated from the rest of the frozen product as a first forming block in the portioning container approximates to a second forming block in the portioning container. The frozen product in the portioning container may be pressed between a first and second forming block as the first and second forming blocks are approximated, to thereby form a substantially spherical dispensable frozen product portion. The second forming block may separate to allow the formed frozen product to be dispensed from the apparatus.

### RELATED APPLICATIONS

This application is a continuation of application Ser. No. 12/401,119, filed Mar. 10, 2009, and titled “Apparatus and Methods for Portioning and Dispensing a Frozen Product,” which claims the benefit under 35 U.S.C. §119(e) of U.S. Provisional Patent Application No. 61/035,336, filed Mar. 10, 2008, and also titled “Apparatus and Methods for Portioning and Dispensing a Frozen Product.” Both of the foregoing applications are incorporated herein by specific reference.

### TECHNICAL FIELD

This disclosure relates generally to an apparatus and methods for dispensing a frozen product.

### BRIEF DESCRIPTION OF THE DRAWINGS

FIG. 1 is a perspective view of one embodiment of a frozen product portioning and dispensing apparatus;

FIG. 2A provides an interior view of the components of one embodiment of a frozen product portioning and dispensing apparatus;

FIG. 2B a cross-sectional view of one embodiment of a frozen product sleeve for use in a frozen product portioning and dispensing apparatus;

FIGS. 4A and 4B provide cross-sectional views of one embodiment of a portioning container for use in a frozen product portioning and dispensing apparatus;

FIG. 5A is a detailed view of an embodiment of a second forming block for use in an embodiment of a frozen product portioning and dispensing apparatus in a closed configuration;

FIG. 5B is a detailed view of an embodiment of a second forming block for use in an embodiment of a frozen product portioning and dispensing apparatus in an open configuration;

FIG. 6 is a detailed view of an alternative embodiment of a second forming block for use in an embodiment of a frozen product portioning and dispensing apparatus;

FIG. 7 is a perspective view of one embodiment of a wiper blade drive and second forming block actuation means;

FIG. 8 is a cut-away view of one embodiment of a second wiper blade drive and second forming block actuation means;

FIG. 9 is a cut-away view of one embodiment of a frozen product portioning and dispensing apparatus;

FIG. 10 is a flow diagram of a sequence of operations for portioning and dispensing a frozen product using one embodiment of a portioning and dispensing apparatus.

FIG. 11 is a perspective cutaway view of an alternative embodiment of a means for moving frozen product.

FIG. 12 is a cross-sectional view of an embodiment of a frozen product portioning apparatus including the means for moving the frozen product shown in FIG. 11.

### DETAILED DESCRIPTION OF PREFERRED EMBODIMENTS

In the following description, numerous specific details are provided for a thorough understanding of the various embodiments of the invention. However, those skilled in the art will recognize that the invention can be practiced without one or more of the specific details, or with other methods, components, materials, etc. In addition, in some cases, well-known structures, materials, or operations are not shown or described in detail in order to avoid obscuring aspects of the invention. Furthermore, the described features, structures, or characteristics may be combined in any suitable manner in one or more embodiments.

Disclosed herein are apparatus and methods for portioning and dispensing a frozen product, such as a frozen food product, a viscous fluid, or any other similar substance. In some embodiments, the frozen product is stored within a storage container that may be refrigerated to maintain the frozen product at a desired temperature. The storage container may comprise means for moving the frozen product disposed therein towards an open end of the container. In some embodiments, the apparatus is automated such that the force used to form a portion of frozen product into a dispensable portion is not provided by an operator.

As the frozen product moves within the storage container, a portion of the frozen product may exit the open end of the storage container into a portioning container. The amount of frozen product that exits the storage container may define a portion size of the frozen product. After a sufficient amount of the frozen product enters the portioning chamber, the movement means may stop, halting the movement of the frozen product towards the open end of the storage container. As such, the means for moving the frozen product may be controllable to allow an operator of the apparatus to control a portion size of the frozen product.

The portioning container may comprise cutting means disposed therein to separate the portion of the frozen product inside the portioning container from the rest of the frozen product in the storage container. The portioning container may comprise two surfaces, which may be used to press the frozen product therebetween to form a dispensable portion.

In an example of an automated apparatus for portioning a plurality of different frozen products according to one embodiment of the invention, a plurality of storage containers is provided. Each of the plurality of storage containers may be configured to store a frozen product such that a plurality of different frozen products can be stored in the apparatus. A plurality of portioning containers corresponding to the plurality of storage containers may also be provided, wherein each of the plurality of portioning containers is configured to form a portion of frozen product into a dispensable portion.

In some embodiments, the plurality of portioning containers each comprise a first forming block and a second forming block. The apparatus may be configured to form the dispensable portion by approximating at least a portion of the first forming block with at least a portion of the second forming block to press a portion of frozen product between the first forming block and the second forming block. The first and second forming blocks may also be configured to form the dispensable portion into an at least approximately spherical shape. In some embodiments, this may be accomplished by providing two substantially hemispherical surfaces that are approximated to form a spherical dispensable portion of frozen product.

For example, the portioning container may include a first substantially hemispherical surface and a second substantially hemispherical surface, wherein the apparatus is configured to form a substantially spherical dispensable portion between the first surface and second surface as the first surface and second surface are approximated.

Some embodiments may also comprise a cutting blade corresponding to each of the portioning containers, wherein the cutting blades are configured to separate a portion of frozen product in a portioning container with which to form the dispensable portion. Of course, other embodiments are contemplated in which a single cutting blade is used for multiple portioning containers. The cutting blade(s) in some embodiments may simply be integral with, or coupled to, one or both of the surfaces that are used to form the dispensable portion of frozen product. In some embodiments, one of the surfaces may be separable to allow the dispensable portion to be dispensed from the apparatus through an opening created by separating the surface.

Some embodiments may also include a wiper, such as a wiper blade, positioned in the portioning container, wherein the wiper is configured to sweep along at least one of the first and second surfaces to facilitate dispensing frozen product.

Some embodiments may also include a belt drive configured to move frozen product within a storage container towards a portioning container or another means for moving the frozen product. The rate with which the belt drive, or another moving means, advances the frozen product may be user selectable. This rate may also affect the amount of frozen product transferred from a storage container to a portioning container.

A refrigeration system may also be provided that is configured to maintain the frozen product in the storage containers at a desired temperature. In some embodiments, the refrigeration system may comprise at least one refrigeration coil wrapped around at least one of the storage containers. In other embodiments, the refrigeration system may include a cold plate that is in contact with one or more of the containers used to store the frozen product. The refrigeration system may also be configured to allow an operator of the apparatus to adjust the temperature of at least one of the storage containers. In some embodiments, the control system may allow an operator of the apparatus to adjust the temperatures of each of the plurality of storage containers independently.

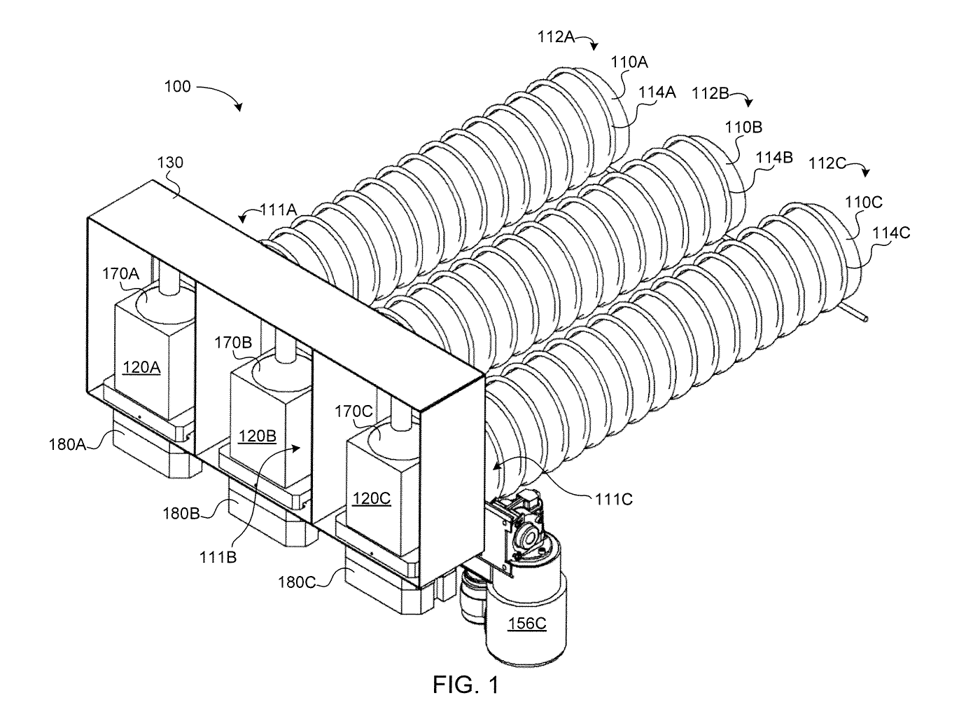

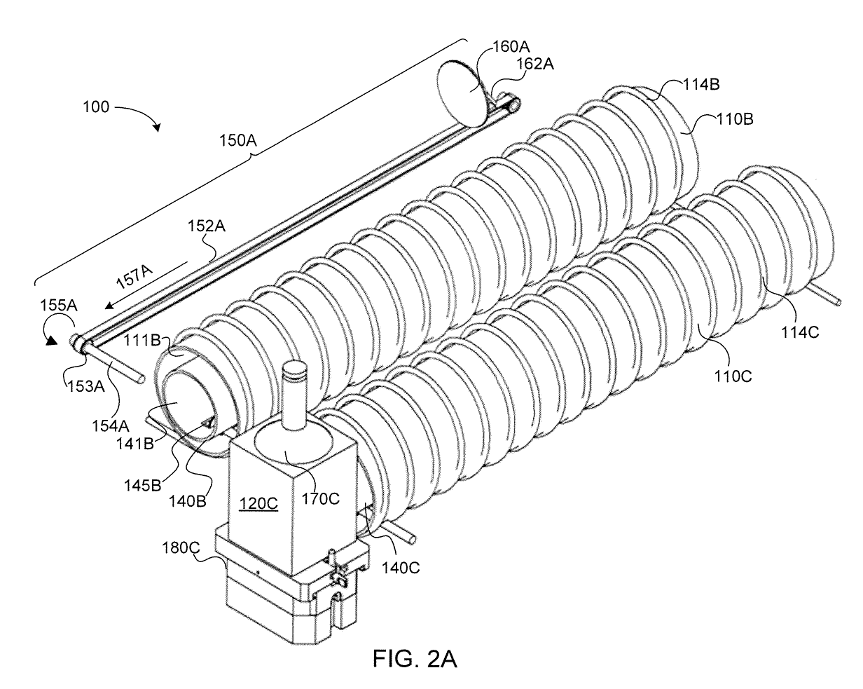

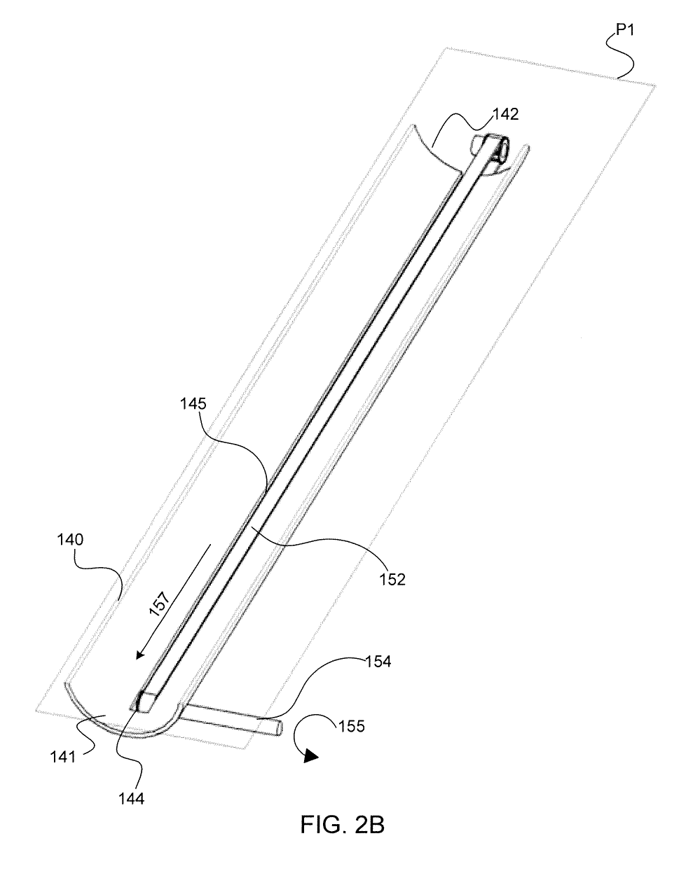

Other specific embodiments will now be discussed and described in greater detail with reference to the accompany figures. FIGS. 1-2 show a perspective view of one embodiment of an apparatus 100 for portioning and dispensing a frozen product. In FIG. 1, the apparatus 100 includes one or more storage containers 110A, 1108, and 110C configured to receive a frozen product (not shown). Although FIG. 1 depicts three cylindrically shaped storage containers 110A-110C, the storage containers 110A-C could be formed in any shape, including, but not limited to rectangular, octagonal, or the like. The shape of the storage containers 110A-110C may be adapted to receive a particular type of frozen product. For example, the apparatus 100 may be adapted to portion a frozen product (not shown) having a rectangular or square shape; in this case, the storage containers 110A-110C may have a rectangular and/or square cross-section. Similarly, although FIG. 1 depicts apparatus 100 as comprising three storage containers 110A-110C, apparatus 100 could be adapted to include any number of storage containers of varying shapes, or only a single storage container.

The various storage containers may store a variety of different frozen products. For example, in one embodiment, a variety of different flavors of ice cream may be provided, each in its own storage container. This allows for a single machine to be used for dispensing a plurality of different ice cream flavors. Alternatively, different kinds of frozen products may be dispensed by the machine. For example, one storage container may contain a frozen yogurt product, a second storage container may contain an ice cream product, and a third storage container may contain a sorbet. Of course, the machine may also be configured to dispense each of the various frozen products, as described in greater detail below.

The apparatus 100 may comprise refrigeration means to maintain the storage containers 110A-110C at an appropriate temperature to keep the frozen product (not shown) within the storage containers 110A-110C in a desired frozen state. For instance, if the apparatus 100 were to be used to portion and dispense hard ice cream, the refrigeration means may be configured to maintain the interior of the storage containers 110A-110C at between about minus four degrees and about two degrees Fahrenheit. If the apparatus 100 were to be used to portion and dispense sorbet, the refrigeration means may be configured to maintain the storage containers 110A-110C at between about minus six degrees and about two degrees Fahrenheit. In one embodiment, the refrigeration means may comprise a refrigeration control system (not shown) to allow an operator of the apparatus 100 to adjust the temperature of the interior of storage containers 110A-110C according to the frozen product stored therein.

For embodiments configured to store and dispense a plurality of different frozen products, each of the various storage containers may be configured to keep the product at a different temperature best suited to the nature of the product. In some embodiments, each of the storage containers may be configured with a separate temperature control such that the particular temperatures for each of the products may be separately varied at will in accordance with the products stored in the containers and/or the particular desires of the users/customers.

The refrigeration means may comprise one or more refrigeration coils 114A, 114B, and 114C. A refrigerant, such as Freon® or the like, may be circulated through the refrigeration coils 114A-114C and a heat exchanger (not shown) using a pump (not shown) or other circulation means, as is well known in the refrigeration arts. The refrigerant circulated through refrigeration coils 114A-114C may be used to cool the storage containers 110A-110C and to maintain the storage containers 110A-110C at a desired temperature. In the FIG. 1 embodiment, the refrigeration coils 114A-114C may be wrapped around the storage containers 110A-110C: refrigeration coil 114A may be wrapped around storage container 114A; refrigeration coil 114B may be wrapped around storage container 114B; and refrigeration coil 114C may be wrapped around storage container 114C. Although FIG. 1 depicts the refrigeration coils 114A-114C wrapped around storage containers 110A-110C, one skilled in the art would recognize that any refrigeration coil 114A-114C configuration could be used under the teachings of this disclosure.

Each of the storage containers 110A-110C may comprise insulating material (not shown) to increase the efficiency of the refrigeration means. Similarly, the storage containers 110A-110C may be housed in an enclosure (not shown) that may also be insulated.

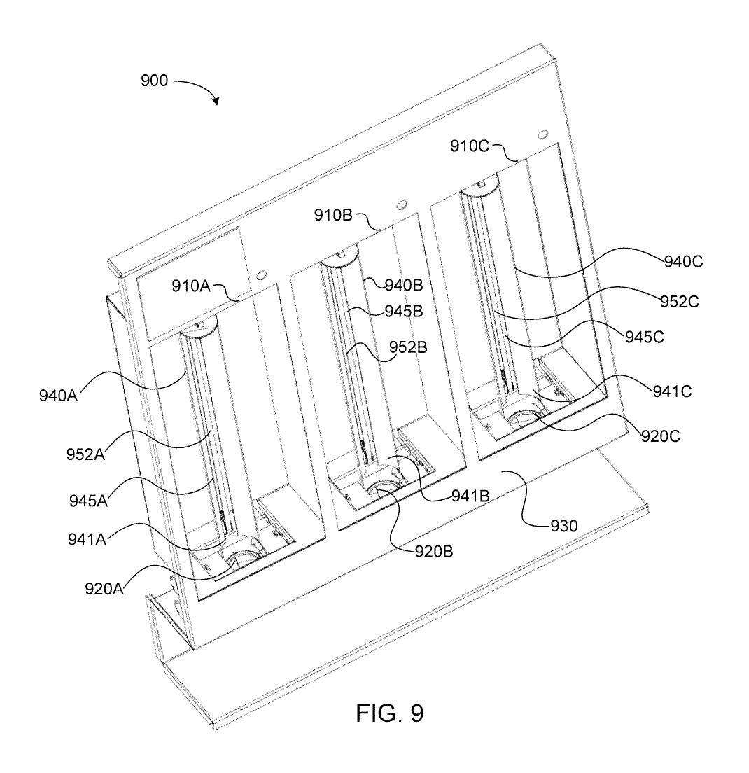

Although FIGS. 1, 2A, and 2B depict a frozen product sleeve 140 having a longitudinal slit 145 beginning near the end 141 of the sleeve 140 and extending to the end 142 of the sleeve, other slit 145 configurations could be used under the teachings of this disclosure. For example, in an alternative embodiment, the longitudinal slit 145 may extend along the entire longitudinal axis of the frozen product sleeve 140. In this case, the slit 145 may bisect the frozen product sleeve 140. This may allow the elastic belt 152 to extend along the entire longitudinal axis of the frozen product sleeve 140. This alternative configuration may prevent a frozen product (not shown) within the frozen product sleeve 140 from becoming stuck on the lip 144 of the longitudinal slit 145. One example of an embodiment employing such a longitudinal slit is shown in FIG. 9.

Referring to FIG. 3, one end 111 of the storage container (e.g., storage containers 110A-110C of FIGS. 1-2) may be open to allow a frozen product to be loaded into an interior 113 of the storage containers 110.

Referring again to FIGS. 1 and 2A, the apparatus 100 may comprise one or more portioning containers disposed in a housing 130. The housing 130 may comprise mounting points to receive the storage containers 110A-110C and the portioning containers 120A-120C. The portioning containers 120A-120C may be mounted proximate to the open end 111A-111C of the storage containers 110A-110C.

The portioning containers 120A-120C may each include an opening (not shown) to allow a portion of frozen product disposed in the storage containers 110A-110C to be transferred to a respective portioning container 120A, 120B, or 120C. The portioning containers 120A, 120B, and 120C may comprise a respective first forming block 170A, 170B, and 170C and a second forming block 180A, 180B, and 180C. As will be discussed below, the first forming blocks 170A-170C and second forming blocks 180A-180C may be used to form a portion of frozen product into a dispensable portion.

FIG. 2A depicts the apparatus 100 without the storage container 110A, the portioning container 110A, the portioning container 110B, and without housing 130. As shown in FIG. 2A, each of the storage containers 110A-110C may be hollow and comprise an open end (e.g., open end 111 B of storage container 110B).

A frozen product sleeve 140B may be configured to be received within each of the storage containers 110A-110C. For example, FIG. 2A shows frozen product sleeves 140B and 140C disposed within storage containers 110B and 110C, respectively. The frozen product sleeve 140B may be hollow and include an opening on least one end 141B. The frozen product sleeve 140B may be adapted to receive a frozen product (not shown). As such, the frozen product sleeves 140B-140C may be configured to have an appropriate cross-section and/or size to receive the frozen product (not shown) to be portioned and dispensed from the apparatus 100.

The apparatus 100 may comprise means for moving a frozen product (not shown) disposed within the frozen product sleeves 140A (not shown), 140B, and 140C from a first end 112A-112C of each of the storage containers 110A-110C to an open end 111A-111C of the storage containers 111A-111C. The means for moving the frozen product may include, but are not limited to: a belt drive powered by an electric motor and/or a pneumatic or hydraulic drive; a pusher plate powered by a screw drive; a hydraulic drive; a pneumatic drive; a manual drive (e.g., a hand crank); or the like.

In some embodiments, the storage containers 110A-110C may be oriented to be above their respective portioning containers 120A-120C. In such embodiments, the movement of the frozen product (not shown) with the storage containers 110A-110C may be assisted by gravity (e.g., the frozen product may tend to slide towards the open end 111A-111C of the storage containers 110A-110C into a respective portioning container 120A-120C).

The apparatus 100 depicted in FIGS. 1-2 includes a belt drive 150 configured to move frozen product (not shown) within the storage containers 110A-110C towards the open end 111A-111C of the containers. For example, a belt drive 150A is visible in FIG. 2A due to removal of the storage container 110A, refrigerant coil 120A, and frozen product sleeve 140A (not shown). The belt drive 150A may comprise an elastic belt 152A attached to a drive shaft 154A via a sprocket 153A, which in turn, may be connected to a motor (not shown).

The frozen product sleeves 141A (not shown), 141B, and 141C may comprise a slit along their respective longitudinal axes. The longitudinal slit may begin near the end 141A-C of the frozen product sleeves 140A-140C, and may continue along the longitudinal axis of the frozen product sleeves 140A-140C to the end 142A-142C of the frozen product sleeves 140A-140C. For example, FIG. 2A depicts a portion of a longitudinal slit 145B in the frozen product sleeve 140B.

Referring to FIG. 2B, a cross-sectional view of an embodiment of a frozen product sleeve 140 is depicted. FIG. 2B shows a longitudinal slit 145 beginning near a first end 141 of the frozen product sleeve 140 and continuing to a second end 142 of the sleeve 140 (a push plate, such as the push plate 160A shown in FIG. 2A is omitted from FIG. 2B to allow the entire longitudinal slit 145 to be visible). The longitudinal slit 145 may be configured to receive an elastic belt 152 therein. As discussed above, a belt, such as elastic belt 152, may be used to move a frozen product (not shown) from the second end 142 of the frozen product sleeve 140 to the first end 141 of the frozen product sleeve 140.

As the drive shaft 154 rotates clockwise, as shown by rotation 155, the elastic belt 152 may move in direction 157 (e.g., in the direction of the end 141 of the frozen product sleeve 140). Referring back to FIG. 2A, this may move the frozen product (not shown) within the storage container 110A towards the open end of the storage container 110A (e.g., depicted as direction 157A in FIG. 2A).

In some embodiments, the movement of the frozen product (not shown) may be facilitated by a push plate 160A attached to the elastic belt 152A. The push plate 160A may be fixedly attached to the elastic belt 152A and supported by a push plate support 162A that may also be removably, fixedly attached to the elastic belt 152A. As the belt 152A moves towards the open end 111A of the storage container 110A in direction 157A, the push plate 160A may similarly move. This may ensure that any frozen product (not shown) within the storage container 110A and/or frozen product sleeve 140A (not shown) will progress toward the open end 111A of the storage container 110A, along with the elastic belt 152A.

The movement of the frozen product (not shown) towards the open end 111A of the storage container 110A and the open end 141A (not shown) of the frozen product sleeve (not shown) will cause a portion of the frozen product to exit the storage container 110A. As the frozen product exits the storage container 110A, it may be received by the portioning container 120A. As such, the portioning container 120A may comprise an opening corresponding to the open end 110A of the storage container 110A and/or the open end 141A (not shown) of the frozen product sleeve 140A (not shown). The portion of frozen product within the portioning container may then be formed into a dispensable portion and dispensed from the apparatus 100.

After dispensing substantially all of the frozen product (not shown) from the storage container (e.g., storage container 110A of FIG. 2A) and/or frozen product sleeve, an operator may reload storage container 110A. Reloading the storage container 110A may comprise removing the portioning container 120A from the housing 130 to expose the open end 111A (see FIG. 2A) of the storage container 110A. The frozen product sleeve 140A (not shown) may then be removed from the storage container 110A and reloaded with frozen product (e.g., the operator may place frozen product within the sleeve 140B). If desired, the elastic belt 152A and the push plate 160A and push plate support 162A may be removed from the sprocket 153A for cleaning and/or maintenance.

After cleaning and/or maintenance, the elastic belt 152A, push plate 160A, and push plate support 162A may be placed onto the sprocket 153A within the storage container 110A. A frozen product may be placed within the frozen product sleeve 140A, which may then be inserted into the storage container 110A. Inserting the frozen product sleeve 140A will cause the push plate 160A to be pushed to the end 112A of the storage container 110A. After insertion of the frozen product sleeve 140A, the operator may replace the portioning container 120A onto the end 111A of the storage container 110A on the housing 130 and reengage the drive shaft 154A to the drive shaft articulation means (not shown).

FIG. 3 shows a cross-sectional view of a storage container 110, portioning container 120, frozen product sleeve 140, first forming block 170, second forming block 180, and belt drive 150, including an elastic belt 152, a belt drive shaft 154, a belt drive sprocket 153, and an electric motor 156.

The width of the elastic belt 152 may be adapted to the type of frozen product 370 used within the frozen product sleeve 140. In some embodiments, the width of the elastic belt 152 may be approximately ½ inch or smaller, and in other embodiments the elastic belt 152 may be approximately 2 ½ inches or wider.

As shown in FIG. 3, one end 111 of the storage container 110 may be open. A second end 112 of the storage container 110 may be enclosed. The frozen product sleeve 140 may be adapted to be received within an interior 113 of the storage container 110. The frozen product sleeve 140 may comprise a hollow interior 143 adapted to receive a frozen product 370. The frozen product sleeve may be open on both ends 141 and 142.

The frozen product sleeve 140 may comprise a longitudinal slit 145, as previously discussed (e.g., element 145 in FIG. 2B). The longitudinal slit 145 may begin near end 141 of the frozen product sleeve 140 and continue to end 142 of the frozen product sleeve 140. The longitudinal slit 145 may be configured to allow the elastic belt 152 to protrude through the longitudinal slit 145 (e.g., may have a width slightly larger than the width of the elastic belt 152) and contact the frozen product 370.

As discussed above, in some embodiments, a push plate 160 and a push plate support member 162 may be removably, fixedly attached to the elastic belt 152. As the elastic belt 152 moves toward the open end 141 of the frozen product sleeve 140 in direction 157, the push plate 160 and push plate support 162 may similarly move. The movement of the push plate 160 may push the frozen product 370 towards the open end 141 of the frozen product sleeve 140.

As the frozen product 370 moves towards the open end 141 of the frozen product sleeve 140 in direction 157, a portion of frozen product 372 may exit the frozen product sleeve 140 into an interior 124 of the portioning container 120 through a portioning container opening 122.

The portioning container 120 may comprise a first forming block 170 and a second forming block 180. In some embodiments, the first forming block 170 may be movably mounted within the porting container 120 to allow the first forming block to approximate to the second forming block 180 (e.g., move in direction 177 towards the second forming block 180).

As the first forming block 170 approximates to the second forming block 180 in direction 177, the portion of frozen product 372A in the portioning container 120 may be separated from the rest of the frozen product 370.

In some embodiments, the separation may be effected by compressive force placed on the frozen product by an edge of the first forming block 170. This compressive force may be applied at or near the demarcation line 371. In other embodiments, the first forming block 170 may comprise a blade 174 attached to the first forming block 170, as shown in FIG. 3. The blade 174 may separate the portion of frozen product 372 within the portioning container 120 from the rest of the frozen product 370 at about the demarcation line 371.

An interior surface 172 of the first forming block 170, and an interior surface 182 of the second forming block 180 may be substantially hemispherically shaped, such that when the first forming block 170 is approximated to the second forming block 180, a substantially spherical shape is formed therefrom. This may cause the portion of frozen product 372 within the portioning container 120 to be formed into a substantially spherical shape as the portion of frozen product 372 is pressed between the first forming block 170 and the second forming block 180.

The first forming block 170 may be moved toward the second forming block 180 in the direction 177 using various approximation means including, but not limited to: a hydraulic press attached to an end 171 of the first forming block, a pneumatic press, an electric motor, a manual press, or the like.

As discussed above, the belt drive 150 may comprise articulation means, such as an electric motor 156 attached to the drive shaft 154 to cause the elastic belt 152 to move towards the end 141 of the frozen product tube 140 along direction 157. The movement of the elastic belt 152 and the push plate 160 disposed thereon may cause any frozen product 370 disposed within the frozen product sleeve 140 to move towards the end 141 of the frozen product sleeve 140. This may cause the portion of frozen product 372 to exit the frozen product sleeve 140 into the interior 124 of the portioning container 120. The belt drive motor 156, belt drive shaft 154, and/or belt sprocket 153 may be configured to monitor the movement of the elastic belt 152. In this way, the amount of frozen product 372 that enters the portioning container 120 may be determined and controlled by an operator or other control system. By monitoring and/or controlling the movement of the elastic belt 152 and corresponding movement of the frozen product 370, the apparatus 100 may control the amount of frozen product 370 that is included in the portion of frozen product 372. Accordingly, an operator or other control system of the apparatus 100 may be capable of determining the size of the frozen product portion 372 by controlling the movement of the elastic belt 152.

For example, the belt drive shaft 154 and/or belt sprocket 153 may comprise one or more sensors, actuation arms, or the like that may be actuated by the movement of the elastic belt 152. The activation of the one or more sensors, actuation arms, or the like may be indicative of the distance traveled by the elastic belt 152 and frozen product 370. Similarly, the belt drive shaft 154 actuation means (not shown) may comprise sensing means capable of detecting the number of rotations made by the belt drive shaft 154. The distance traveled by the elastic belt 152 and frozen product 370 may be determined by the number of turns of the belt drive shaft 154 and the size of the belt drive sprocket 153. One skilled in the art would recognize that any number of detection and/or monitoring means could be used to determine the distance traveled by the elastic belt 152 and frozen product 370 under the teachings of this disclosure.

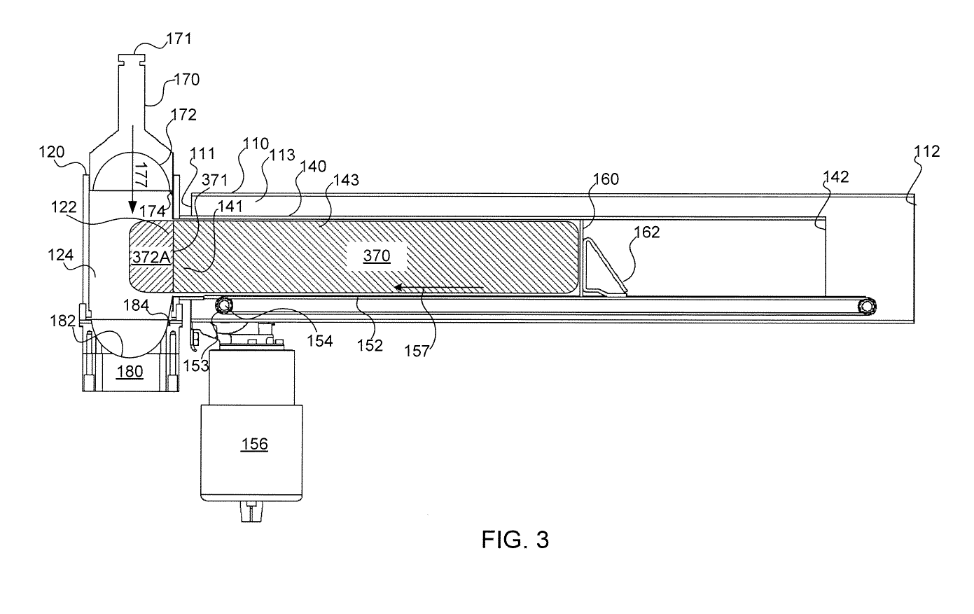

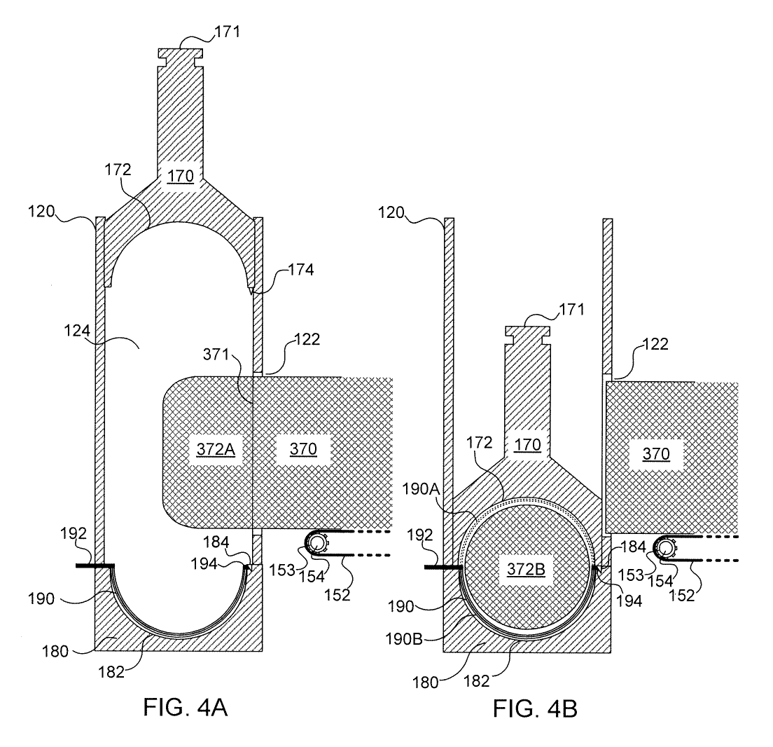

FIG. 4A shows a cross-sectional view of the portioning container 120, the first forming block 170, and the second forming block 180. As shown in FIG. 4, an interior surface 172 of the first forming block 170 may be substantially spherical and may comprise a blade 174 disposed on an outer lip of the first forming block 170. Similarly, the interior surface 182 of the second forming block 180 may be substantially spherical, such that when the first forming block 170 is approximated to the second forming block 180, a substantially spherical void is formed therefrom (e.g., as shown in FIG. 4B at 372B).

As discussed above, the portioning container 120 may comprise an opening 122 configured to allow a portion of frozen product 372A to enter into the interior 124 of the portioning container 120. As discussed above, the frozen product 370 may be stored in a refrigerated storage container (not shown) having a frozen product sleeve (not shown) disposed therein. The frozen product 370 may be moved into the portioning container 120 using movement means, such as an elastic belt 152 or the like. The elastic belt 152, or a cover thereon (not shown), may contact the frozen product 370 and—as the belt is moved via the belt drive shaft 154, belt drive sprocket 153, and belt articulation means (not shown)—the frozen product 370 may be moved towards the opening 122 of the portioning container 120.

A portion of frozen product 372A may enter the portioning container 120 through the opening 122. The size of the frozen product portion 372A (e.g., the amount of frozen product 370 that enters the portioning container 120) may be determined by controlling the rotation of the belt drive shaft 154 by the belt articulation means (not shown).

After an appropriate amount of frozen product 372A has entered the portioning container 120, the belt articulation means (not shown) may stop the belt drive shaft 154, thereby stopping the elastic belt 152 and the movement of the frozen product 370 into the portioning container 120. As shown in FIG. 4A, when the movement of the frozen product 370 stops, a portion of frozen product 372A may be disposed within the interior 124 of the portioning chamber 120.

As discussed above, the first forming block 170 may be movably disposed within the portioning container 120. Pressing means, such as a hydraulic press, pneumatic press, manual press, or the like (not shown) may be applied to an upper portion 171 of the first forming block 170 to approximate the first forming block 170 to the second forming block 180 in the direction 177. As the first forming block 170 moves towards the second forming block 180, the first forming block may separate the frozen product portion 372A from the rest of the frozen product 370 at approximately the demarcation line 371.

In some embodiments, the separation of the frozen product portion 372A from the rest of the frozen product 370 may be effected by a compressive force applied by an edge of the first forming block 170. In other embodiments, the separation may be effected by a blade 174 disposed on an outer edge of the first forming block 170. The second forming block 180 may comprise a detent 184 adapted to receive the blade 174 in such embodiments.

As shown in FIG. 4B, when the first forming block 170 approximates to the second forming block 180, the frozen product portion 372A may be separated from the rest of the frozen product 370 and pressed between an interior surface 172 of the first forming block 170 and an interior surface 182 of the second forming block 180. Since the inner surface 172 of the first forming block 170 and the inner surface 182 of the second forming block 180 are both substantially hemispherical, the resulting volume when the first forming block 170 is approximated to the second forming block 180 is substantially spherical. As shown in FIG. 4B, the portion of frozen product 372B pressed between inner surface 172 of the first forming block 170 and the inner surface 182 of the second forming block 180 may be substantially spherical in shape.

A means for dispensing the frozen product may also be provided. For example, a wiper blade 190 may be rotatably positioned within portioning container 120 adjacent to the interior surface 182 of the second forming block 180 to facilitate dispensing the formed portion of frozen product. The wiper blade 190 may be attached to a wiper support 194 and wiper rotation shaft 192, which may in turn be attached to wiper blade rotation means (not shown), such as an electric motor, a hydraulic motor, a pneumatic motor, a manual crank, or the like. The rotation means (not shown) may be configured to rotate the wiper blade 190 in a first rotation pattern comprising a substantially 360-degree rotation of the wiper blade 190 and a second rotation patter comprising a substantially 180-degree rotation of the wiper blade 190.

The rotation means (not shown) may be configured to rotate the wiper blade 190 in the first rotation pattern when the first forming block 170 is approximated to the second forming block 180 as shown in FIG. 4B. In this configuration, the 360-degree rotation of the wiper blade 190 will cause the wiper blade 190 to rotate in hemisphere 190A to wipe the interior surface 172 of the first forming block 170 and to rotate in hemisphere 190B to wipe the interior surface 182 of the second forming block 180. The rotation of the wiper blade 190 in the first rotation pattern may prevent the formed frozen product portion 372B from sticking to the interior 172 of the first forming block 170 and/or the interior 182 of the second forming block 180.

In some embodiments, the second forming block 180 may be separable so as to form an opening in the portioning container 120. The features and components that allow for forming such a dispensing opening may be considered another example of a means for dispensing. In such embodiments, after the first forming block 170 is approximated to the second forming block 180 (as shown in FIG. 4B), the second forming block 180 may separate to allow the frozen product portion 372B to be dispensed from the portioning container 120.

When the second forming block 180 separates, the rotation means (not shown) may cause the wiper blade 190 to rotate in the second rotation pattern. In the second rotation pattern, the 180-degree rotation of the wiper blade 190 may be restricted to substantially hemisphere 190A, causing cause the wiper blade 190 to wipe the interior surface 172 of the first forming block 170. Since the second rotation pattern only comprises a substantially 180-degree rotation, the wiper 190 may not rotate in hemisphere 190B.

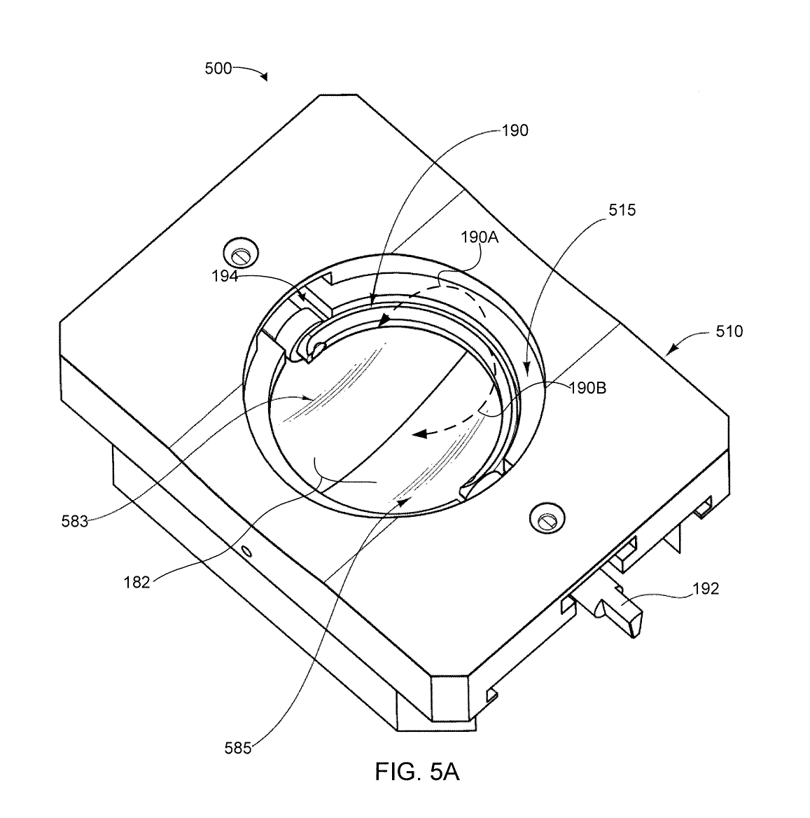

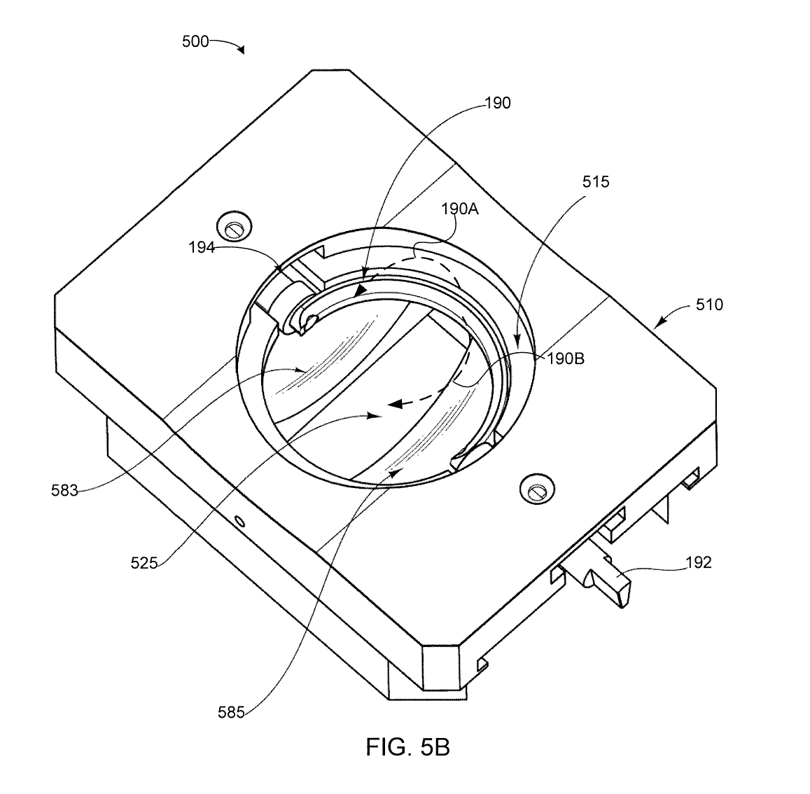

Rotation of the wiper blade 190 according to the second rotation pattern after separation of the second forming block 180 may be desirable since rotation of the wiper blade in the hemisphere 190B (occupied by interior surface 182 of second forming block 180 before separation of the second forming block 180) may prevent the portion of frozen product 372B from exiting the portioning container 120. Moreover, rotation in the second hemisphere 190B during separation of the second forming block 180 may constitute a potential safety hazard. Separation of the second forming block 180 is discussed in additional detail below in conjunction with FIGS. 5A and 5B.

FIGS. 5A and 5B provide a detailed view of one embodiment of a second forming block 500. The second forming block 500 includes a second forming block body 510, which may be adapted to be connected to a portioning container (not shown), such as the portioning container 120 depicted in FIGS. 1-4. The second forming block body 510 may be further adapted to allow for selective attachment and removal of the second forming block 500 from the portioning container (not shown) for cleaning, maintenance, or the like.

The second forming block 500 may comprise a hemispherically shaped inner surface 182 for forming a frozen product portion into a dispensable, substantially spherical portion. As shown in FIG. 4B, a frozen product portion 372B may be formed into a substantially spherical shape when pressed between a substantially hemispherical surface 172 of the first forming block 170 and a substantially hemispherical surface 182 of the second forming block 180.

Referring again to FIG. 5A, the hemispherical surface 182 of the second forming block 500 may be comprised of two separable surfaces: 583 and 585. When joined, the separable surfaces 583 and 585 may form a substantially hemispherical inner surface 182.

FIG. 5B depicts second forming block 500 after separable surfaces 583 and 585 have been partially separated. As shown in FIG. 5B, the separation of separable surfaces 583 and 585 may create an opening 525 in the second forming block 500. In some embodiments, a formed portion of frozen product, such as the frozen product portion 372B of FIG. 4 may be dispensed from the apparatus through the opening 525.

The body 510 of second forming block 500 may comprise a recessed portion 515. The recessed portion 515 may be configured to connect with a first forming block (not shown), such as the first forming block 170 shown in FIGS. 1-4. As discussed above, in some embodiments, the first forming block (not shown) may be hemispherically shaped. When the first forming block (not shown) is approximated to the second forming block 500, the first forming block (not shown) may fit into and mate with the recessed area 515 of the second forming block 500. As shown in FIG. 4B, the resulting combination may create a generally spherical area between the first and second forming blocks 170 and 180. Thus, a portion of frozen product pressed between the first forming block and second forming block 500 may be formed into a generally spherical shape. (e.g., the frozen product portion 372B depicted in FIG. 4B).

The second forming block 500 may comprise a wiper blade 190 rotatably mounted on the second forming block body 510 proximate to the second forming block 182 comprised of separable surfaces 583 and 585 using a rotatable support 194 and wiper blade rotation shaft 192. The wiper blade rotation shaft 192 may be coupled to rotation means (not shown) configured to cause the wiper blade to rotate in a first rotation pattern and a second rotation pattern.

As described above, in the first rotation pattern, the wiper blade 190 may rotate in a substantially 360-degree rotation pattern. The wiper blade 190 may be configured to rotate in the first rotation pattern when the separable surfaces 583 and 585 are joined as shown in FIG. 5A. In this configuration, the wiper blade 190 will rotate in the hemisphere 190B and may wipe the separable surfaces 583 and 585. In addition, the wiper blade 190 may rotate in the hemisphere 190A above the separable surfaces 583 and 585. As such, when the second forming block 500 is connected to a portioning container (not shown) as depicted in FIG. 4A and 4B, and when the first forming block (not shown) is approximated to the second forming block 500 as depicted in FIG. 4B, the rotation of the wiper blade 190 in the first pattern may wipe the inner surface (not shown) of the first forming block (not shown). For example, FIG. 4B depicts the first forming block 170 approximate to the second forming block 180. In this configuration, the first rotation pattern will cause the wiper blade to rotate in hemispheres 190A and 190B, thereby causing the wiper blade 190 will to wipe both the inner surface 172 of the first forming block 170 and the inner surface 182 of the second forming block 180.

Referring to FIG. 5B, the separable surfaces 583 and 585 may be configured to separate to form an opening 525 in the second forming block 500. As discussed above, the opening 525 in the second forming block may be used to dispense a portion of frozen product (not shown) from a portioning container (not shown). When the separable surfaces 583 and 585 are separated, the wiper blade 190 may be configured to rotate in the second rotation pattern. As described above, in the second rotation pattern, the wiper blade 190 may rotate in a substantially 180-degree rotation pattern within the first hemisphere 190A. As such, in the second rotation pattern, the wiper blade 190 may not rotate in the hemisphere 190B. The second rotation pattern may prevent the wiper blade 190 from blocking the opening 525 in the second forming block. This may allow a portion of frozen product (not shown) to be dispensed from the opening 525 of the second forming block 500. In addition, the rotation of the wiper blade 190 in the first hemisphere 190A may prevent the portion of frozen product (not shown) from sticking to the first forming block (not shown) and act to push the portion of frozen product (not shown) out through the opening 525.

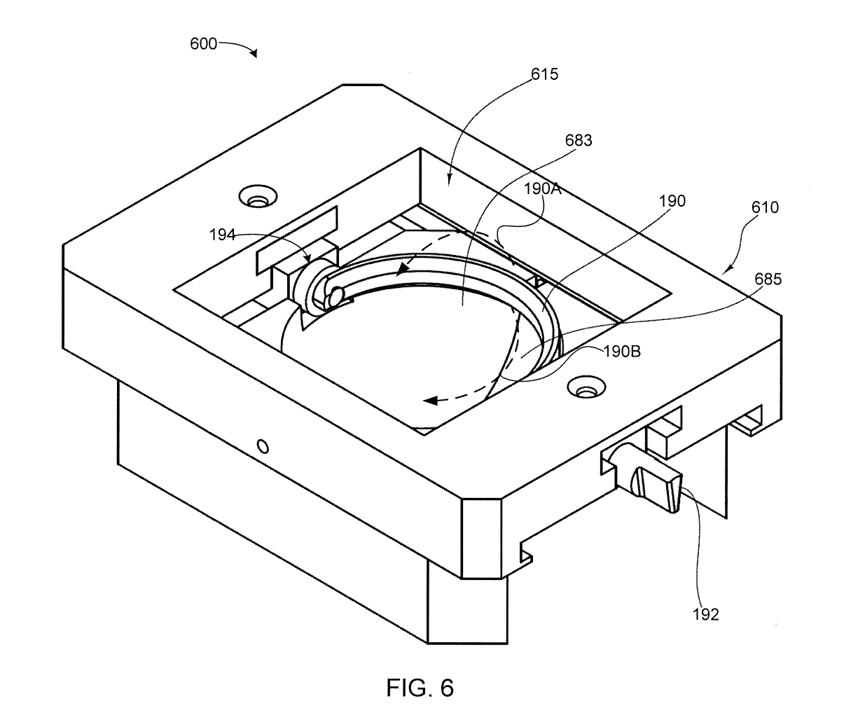

FIG. 6 depicts an alternative second forming block assembly 600 that may be used in other embodiments of the invention. Unlike second forming block assembly 500 of FIGS. 6A and 6B, second forming block assembly 600 has a recessed portion 615 that has a rectangular cross-section. Second forming block assembly 600 is otherwise similar to second forming block assembly 500 of FIGS. 5A and 5B, and includes a second forming block body 610 having a wiper blade 190, attached to a wiper support shaft 192, and a wiper rotation shaft 194 disposed thereon. As discussed above, the wiper blade 190 may be configured to rotate the wiper blade 190 in a first rotation pattern and a second rotation pattern. When separable surfaces 683 and 685 are joined, the wiper blade 190 may be configured to rotate in a first, 360-degree rotation pattern, and when the separable surfaces 683 and 685 are separated, the wiper blade 190 may be configured to rotate in a second, 180-degree rotation pattern.

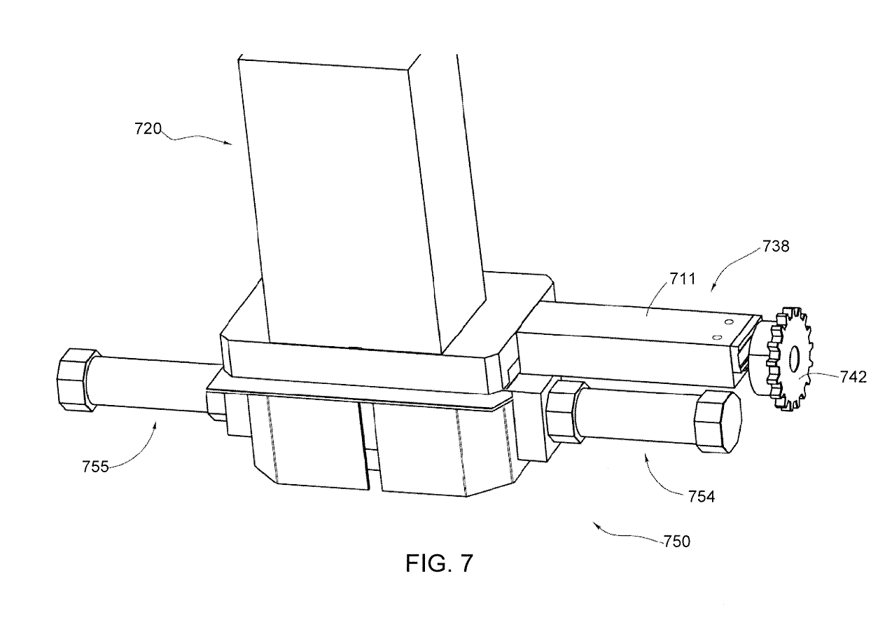

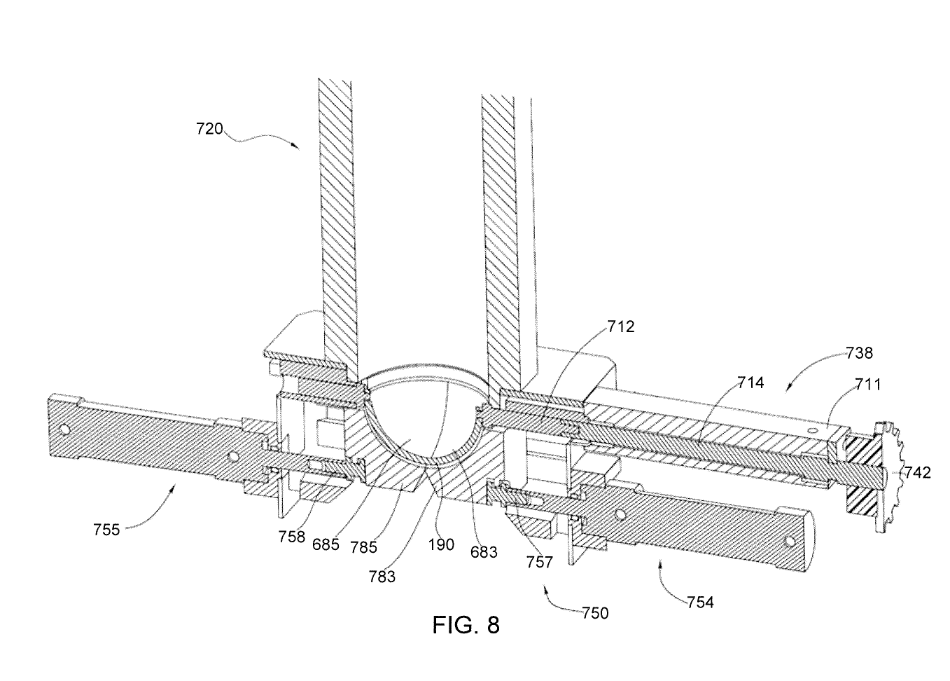

FIGS. 7 and 8 depict additional details regarding mechanisms that may be used to separate separable surfaces 683 and 685 and re-approximate separable surfaces 683 and 685 in one or more particular embodiments. FIGS. 7 and 8 depict a portioning container 720, which may be similar to portioning container 120, as previously described. FIGS. 7 and 8 also depict a wiper drive assembly 738, which includes a housing 711, a wiper drive gear 742, and a drive shaft 714. The wiper drive gear 742 may be connected with any suitable power source for driving the wiper drive gear 742, as those having ordinary skill in the art will appreciate, such as electric, hydraulic, pneumatic, and/or manual rotation means. Rotation of the wiper drive gear 742 causes drive shaft 714 to rotate, which, in turn, causes wiper blade 190 to rotate.

FIGS. 7 and 8 also depict a second forming block actuation assembly 750, which is configured to result in the separation of surfaces 683 and 685 to create an opening in the second forming block 180 as previously described. The second forming block actuation assembly 750 in FIGS. 7 and 8 comprises a lower surface actuation assembly and includes two air cylinders—first air cylinder 754 and second air cylinder 755. The first air cylinder 754 is configured to provide the force for moving surface 683 and second air cylinder 755 is configured to provide the force for moving surface 685. As shown in FIG. 8, the air cylinders 754 and 755 have corresponding actuation members 757 and 758, respectively, with which they are connected. Actuation members 757 and 758 fit within mating recessed regions formed within the blocks 785 and 783 defining surfaces 685 and 683, respectively. As such, when the respective air cylinders 750/755 are actuated, their associated actuation members 757/758 pull on blocks 785/783 to thereby separate surfaces 685/683.

Although FIGS. 1, 2A, and 2B (and related FIGS. 3-8) show the storage containers 110A-110C in a generally horizontal configuration, other configurations and/or orientations of the storage containers 110A-110C could be used under the teachings of this disclosure.

In one alternative embodiment, the storage containers 110A-110C may be oriented in a substantially vertical configuration. In this case, gravitational forces on the frozen product (not shown) within the storage containers 110A-110C may assist in moving the frozen product towards the open end 111A-111C of the storage containers 110A-110C. In this embodiment, the apparatus 900 may include supplementary frozen product movement means (e.g., a belt drive, push plate, or the like). Alternatively, the storage containers 110A-110C may be in an angled configuration (e.g., between a horizontal configuration shown in FIGS. 1, 2A, and 2B and vertical configuration shown in FIG. 9). The angled configuration may cause gravitational forces to assist the movement of the frozen product towards the open end 111A-111C of the storage containers 110A-110C. Other embodiments are contemplated in which no movement means are provided such that gravity alone moves the frozen product into the respective portioning containers 120A-120C.

FIG. 9 shows one embodiment of a portioning and dispensing apparatus 900 having a substantially vertical configuration. As shown in FIG. 9, the frozen product sleeves 940A-940C may be oriented within respective, substantially-rectangular storage containers 910A-910C in a housing 930. The frozen product sleeves 940A-940C may be in a substantially vertical configuration. Each of the frozen product sleeves 940A-940C may comprise a respective longitudinal slit 945A-945C. In the FIG. 9 embodiment, the slits 945A-945C may run the entire length of the frozen product sleeves 940A-940C. As discussed above, this may allow an elastic belt 952A-952C to run the full length of the respective frozen product sleeves 940A-940C.

A respective portioning container 920A-920C may be disposed at a bottom end 941A-941C of each of the frozen product sleeves 940A-940C. The elastic belts 952A-952C may be used to advance the frozen products (not shown) within the frozen product sleeves 940A-940C into the portioning containers 920A-920C. In an alternative embodiment, a gravitational force on the frozen products may be used to advance the frozen product into the respective portioning container 920A-920C.

Although not shown in FIG. 9, the portioning container may comprise a first forming block and a second forming block similar to the first forming block 170 and second forming block 180 discussed above. The first and second forming blocks may be separable. The first forming block may separate to form an opening (e.g., openings 922A-922C) in the portioning container 920A-920C. A portion of frozen product may enter the portioning container 920A-920C. The first forming block may close, thereby separating the portion of frozen product within the portioning container 920A-920C from the rest of the frozen product. The first forming block and the second forming block may be approximated, pressing the frozen product portion therebetween. An inner surface (not shown) of the first forming block and an inner surface (not shown) of the second forming block may form a substantially spherical shape. As such, the frozen product portion may be formed in to a substantially spherical portion. After formation, the second forming block may separate to allow the formed portion to be dispensed from the resulting opening.

In addition, the apparatus 900 may comprise a wiper blade (not shown) to wipe the interior surface of the first and second forming blocks and to assist the portion of frozen product to exit the opening in the second forming block substantially as described above.

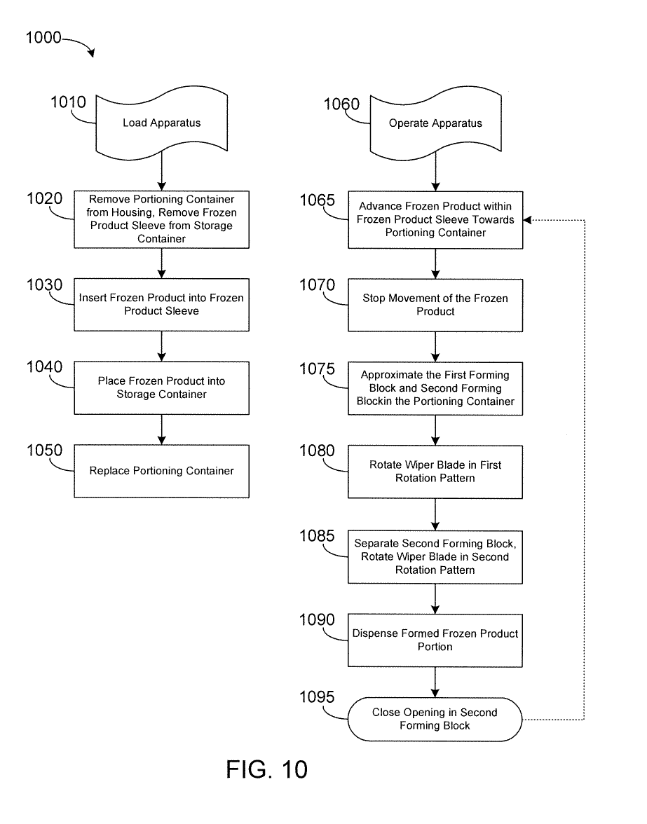

FIG. 10 shows two flow diagrams 1000 of a sequence of operations to load and operate one embodiment of the portioning and dispensing apparatus disclosed herein.

At 1010, the portioning and dispensing apparatus may be loaded and prepared for use. This may comprise a series of individual steps, such as steps 1020 to 1050. At 1020, the portioning container, such as the portioning container 120 depicted in FIGS. 1-4 and/or portioning container 720 depicted in FIGS. 7-8 may be removed from the housing of the apparatus. Removal of the portioning container will expose the interior of the apparatus storage container. This allows an operator to remove the frozen product sleeve from within the storage container. In addition, the user may also remove the belt drive and/or push plate movement means for cleaning and/or maintenance.

At 1030, frozen product may be inserted into the frozen product sleeve. At 1040, the frozen product sleeve may be placed back into the apparatus storage container. If the drive belt and/or push plate were removed at step 1020, they may be replaced before the frozen product sleeve is mounted into the storage container. At step 1050, the apparatus is readied for operation by replacing the portioning container.

As discussed above, the apparatus disclosed herein may comprise a plurality of storage containers to house a plurality of frozen products. Steps 1010-950 may be repeated for each of the storage containers of the apparatus. In this way, the apparatus may dispense a variety of different types of frozen products.

At 1060, the apparatus is operated to portion and dispense the frozen product. In this particular embodiment, the operation of the apparatus consists of steps 1065 through 1095. At 1065, the frozen product within the frozen product sleeve may be advanced towards the portioning container using frozen product movement means such as a belt drive, push plate, or the like. As discussed above, as the frozen product moves, a portion of the frozen product enters an opening of the portioning container. At 1070, after a sufficient amount of frozen product has entered the portioning container, the frozen product movement may stop. In embodiments employing a belt drive, the movement of 1065 may be achieved by causing a belt drive and push plate to advance to frozen product into the portioning container. As such, at 1070, the belt drive may be stopped to stop the movement of the frozen product. The size of the portion of frozen product within the portioning container may be controlled by controlling the movement of the belt drive at 1065 and 1070.

At 1075, a first forming block and second forming block within the portioning container may be approximated. The approximation of the first and second forming blocks will separate the portion of frozen product within the portioning container from the rest of the frozen product remaining in the frozen product sleeve and storage container. The separation may performed by compression of the frozen product by the first and/or second forming blocks. In some embodiments, the first and/or second forming block may comprise a blade to separate the portion of frozen product in the portioning container from the rest of the frozen product.

In addition, at 1075, the portion of frozen product may be formed into a dispensable portion. As discussed above, inner surfaces of the first and the second forming block may be substantially hemispherical in shape. As such, as the first and second forming blocks are approximated, the portion of frozen product disposed therebetween will be formed into a substantially spherical shape.

At 1080, a wiper blade disposed within the portioning container may rotate in a first rotation pattern comprising a substantially 360-degree rotation. This may cause the wiper blade to wipe the inner surface of the first forming block and the inner surface of the second forming block.

At 1085, the second forming block may separate to thereby create an opening in the second forming block from which the formed frozen product portion may be dispensed. In addition, at step 1085, the wiper blade may rotate in a second rotation pattern comprising a substantially 180-degree rotation. This may cause the wiper blade to only wipe the inner surface of the first forming block. The second rotation pattern may prevent the wiper blade from blocking the opening in the second forming block and may push the formed frozen product portion from the opening in the second forming block.

At 1090, the formed frozen product may be dispensed from the opening in the second forming block. At 1095, the second forming block may join to close the opening in the second forming block in preparation for the next use of the apparatus.

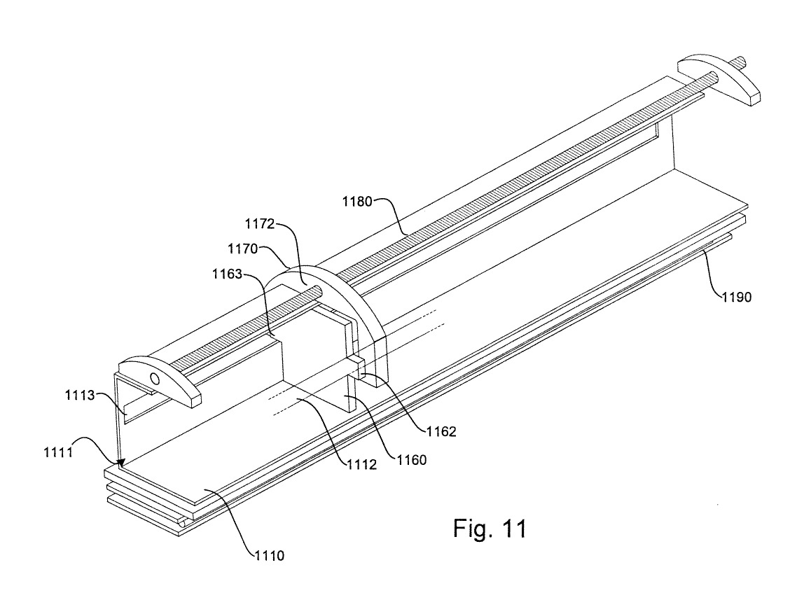

FIG. 11 shows an alternative embodiment of a means for pushing a frozen product. Part of the device is shown in a cutaway view to better expose the internal components of the device. As shown in this figure, a push plate 1160 is provided, which is configured to contact a frozen product (not shown in FIG. 11), or a container with frozen product therein, to push the frozen product towards an open end 1111 of the storage container 1110. Storage container 1110 includes opposing slots 1112 and 1113. Slots 1112 and 1113 are configured to guide push plate 1160 as it moves along the length of storage container 1110. A guide member 1162 on push plate 1160 is configured to fit within slot 1112 to as to connect push plate 1160 with slot 1112. In the depicted embodiment, a second guide member 1163 (partially obscured in FIG. 11) is also provided, and is configured to be received within the opposing slot 1113.

A driving member 1170 is also provided. Driving member 1170 is coupled with push plate 1160 and extends outside of, and above, storage container 1110. Driving member 1170 includes a threaded opening 1172. Threaded opening 1172 receives a threaded member 1180. In the depicted embodiment, the threaded member comprises a bolt. When threaded bolt 1180 is turned, driving member 1170 is moved forward or backward, depending on the direction of rotation of bolt 1180. Because driving member 1170 is coupled with push plate 1160, movement of driving member 1170 in a forward direction (towards open end 1111) results in a corresponding forward movement of any frozen product within storage container 1110. In the embodiment of FIG. 11, the threaded bolt 1180 is stationary relative to the supply container 1110, even while it is being turned. Again, rotation of the threaded member drives the push plate 1160 forward or backwards, but the bolt itself does not move (aside from rotating about its axis).

Those of ordinary skill in the art will appreciate that a motor, manual crank handle, or other means for generating force (not shown in FIG. 11) may be provided to generate the force needed to turn threaded bolt 1180 and thereby move frozen product within the storage container 1110. It should also be understood that rotation of threaded bolt in the opposite direction will return push plate 1160 to the rear of the storage container to allow for reloading of frozen product. Moreover, it should be appreciated that a variety of alternative embodiments are contemplated and/or would be apparent to one of ordinary skill after having received the benefit of this disclosure. For example, embodiments are contemplated in which the driving member need not be present. In such embodiments, the push plate itself could be threaded such that the threaded bolt contacts the push plate directly to provide the driving force.

The embodiment of FIG. 11 also includes an alternative refrigeration means. A cold plate 1190 is provided that is in contact with the storage container 1110. Cold plate 1190 may be kept at a desired temperature according to known methods and/or with known refrigeration/heat-exchange technology.

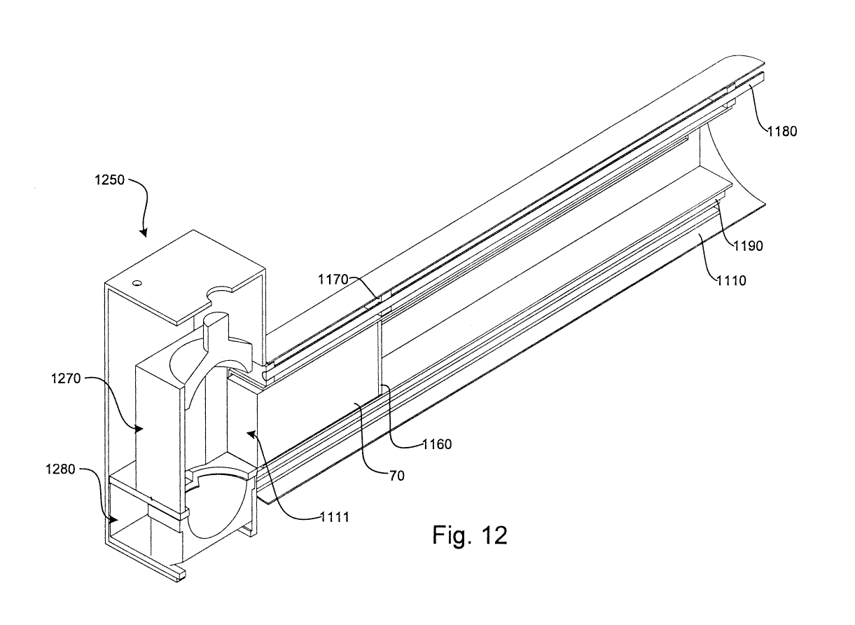

FIG. 12 provides a cross-sectional view of an alternative embodiment of a frozen product portioning apparatus. The apparatus of FIG. 12 includes the means for moving the frozen product shown in FIG. 11. More particularly, FIG. 12 shows the push plate 1160 advancing a frozen product 70 within storage container 1110. Frozen product 70 is being advanced into portioning container 1250, which includes a first forming block 1270 and a second forming block 1280, as described in great detail in connection with other embodiments.

All of the storage containers described herein are examples of means for storing frozen products. All of the push plates and belt drives described herein are examples of means for moving frozen product from a storing means to a forming means. All of the portioning containers described herein are examples of means for forming frozen product into a dispensable portion. All of the cutting blades described herein are examples of means for separating a portion of frozen product with which to form a dispensable portion. All of the refrigeration devices described herein, including the refrigeration coils and cold plates described herein, are examples of means for refrigerating a frozen product. The refrigeration means may also include a refrigeration control system to allow an operator of the apparatus to adjust the temperature of the storing means. All of the wiper blades and separable surfaces described herein are examples of means for dispensing a formed portion of the frozen product.

The above description fully discloses the invention including preferred embodiments thereof. Without further elaboration, it is believed that one skilled in the art can use the preceding description to utilize the invention to its fullest extent. Therefore the examples and embodiments disclosed herein are to be construed as merely illustrative and not a limitation of the scope of the present invention in any way.

It will be obvious to those having skill in the art that many changes may be made to the details of the above-described embodiments without departing from the underlying principles of the invention. The scope of the present invention should, therefore, be determined only by the following claims.

1. An apparatus for portioning a plurality of different frozen products, comprising:
a plurality of storage containers, wherein each of the plurality of storage containers is configured to store a frozen product such that a plurality of different frozen products can be stored in the apparatus; and
a plurality of portioning containers corresponding to the plurality of storage containers, wherein each of the plurality of portioning containers is configured to form a portion of frozen product into a dispensable portion.

2. The apparatus of claim 1, wherein the plurality of portioning containers each comprise:
a first forming block; and
a second forming block, wherein the apparatus is configured to form the dispensable portion by approximating at least a portion of the first forming block with at least a portion of the second forming block to press a portion of frozen product between the first forming block and the second forming block.

3. The apparatus of claim 2, wherein the first and second forming blocks are configured to form the dispensable portion into an at least approximately spherical shape.

4. The apparatus of claim 1, further comprising a cutting blade configured to separate a portion of frozen product in a portioning container with which to form the dispensable portion.

5. The apparatus of claim 4, further comprising a cutting blade corresponding to each of the portioning containers, wherein the cutting blades are configured to separate a portion of frozen product in a portioning container with which to form the dispensable portion.

6. The apparatus of claim 1, wherein each of the portioning containers comprises:
a first substantially hemispherical surface; and
a second substantially hemispherical surface, wherein the apparatus is configured to form a substantially spherical dispensable portion between the first surface and second surface as the first surface and second surface are approximated.

7. The apparatus of claim 6, wherein the second surface is separable to allow the dispensable portion to be dispensed from the apparatus.

8. The apparatus of claim 6, further comprising a wiper positioned in the portioning container, wherein the wiper is configured to sweep along at least one of the first and second surfaces to facilitate dispensing frozen product.

9. The apparatus of claim 1, further comprising a belt drive configured to move frozen product within a storage container towards a portioning container.

10. The apparatus of claim 9, wherein the rate with which the belt drive advances is user selectable, and wherein the belt drive rate affects the amount of frozen product transferred from a storage container to a portioning container.

11. The apparatus of claim 1, further comprising a refrigeration system configured to maintain the frozen product in the storage containers at a desired temperature.

12. The apparatus of claim 11, wherein the refrigeration system comprises at least one of:
at least one refrigeration coil in contact with at least one of the storage containers; and
a cold plate in contact with at least one of the storage containers.

13. The apparatus of claim 11, wherein the refrigeration system is configured to allow an operator of the apparatus to adjust the temperature of at least one of the storage containers.

14. The apparatus of claim 13, wherein the refrigeration system is configured to allow an operator of the apparatus to adjust the temperatures of each of the plurality of storage containers independently.

15. The apparatus of claim 1, wherein the apparatus is automated such that the force used to form a portion of frozen product into a dispensable portion is not provided by an operator.

16. The apparatus of claim 1, further comprising a push plate configured to advance frozen product within at least one of the storage containers.

17. The apparatus of claim 16, further comprising a threaded member connected with the push plate such that the push plate is advanced when the threaded member is turned.

18. The apparatus of claim 17, wherein the apparatus is configured such that the threaded member is stationary relative to the supply containers while the threaded member is being turned.

19. The apparatus of claim 18, further comprising an intermediary driving member comprising a threaded opening to receive the threaded member, wherein the driving member is threadably coupled to the threaded member.

20. An automated apparatus for portioning a frozen product, comprising:
means for storing a plurality of different frozen products;
means for forming frozen product into a dispensable portion; and
means for moving frozen product from the storing means to the forming means.

21. The apparatus of claim 20, further comprising means for separating a portion of frozen product with which to form a dispensable portion.

22. The apparatus of claim 20, further comprising means for refrigerating frozen product.

23. The apparatus of claim 22, wherein the means for refrigerating comprises a refrigeration control system to allow an operator of the apparatus to adjust the temperature of the storing means.

24. The apparatus of claim 22, wherein the means for refrigerating comprises at least one of:
at least one refrigeration coil in contact with the storing means; and
a cold plate in contact with the storing means.

25. The apparatus of claim 20, wherein the means for moving frozen product is user-controllable to allow an operator of the apparatus to control a portion size of the frozen product.

26. The apparatus of claim 20, wherein the means for moving frozen product comprises at least one of a belt drive and a push plate.

27. The apparatus of claim 20, further comprising means for dispensing a formed portion of the frozen product.

28. The apparatus of claim 27, wherein the means for dispensing comprises at least two separable surfaces configured to be selectively separated to allow for a dispensable portion of frozen product to be dispensed from the apparatus.

29. The apparatus of claim 27, wherein the means for dispensing comprises at least one wiper blade.

30. An automated apparatus for portioning and dispensing a frozen food product, comprising:
a plurality of storage containers, wherein each of the plurality of storage containers is configured to store a frozen product such that a plurality of different frozen products can be stored in the apparatus;
a plurality of portioning containers corresponding to the plurality of storage containers, wherein each of the plurality of portioning containers is configured to form a portion of frozen product into a dispensable portion, and wherein each of the plurality of portioning containers comprises:
a first forming block comprising a first substantially hemispherical surface; and
a second forming block comprising a second substantially hemispherical surface, wherein the apparatus is configured to form a substantially spherical dispensable portion by approximating the first surface with the second surface to press a portion of frozen product between the first surface and the second surface, and wherein the second surface is separable to allow the substantially spherical dispensable portion to be dispensed from the apparatus;
a cutting blade corresponding to each of the portioning containers, wherein the cutting blades are configured to separate a portion of frozen product in a portioning container with which to form a dispensable portion; and
a wiper blade corresponding to each of the portioning containers, wherein each of the wiper blades is configured to wipe at least one of the first and second substantially hemispherical surfaces of its corresponding portioning container.

31. An apparatus for portioning a frozen product, comprising:
a storage container configured to store a frozen product;
a portioning container configured to form a portion of frozen product into a dispensable portion;
a push plate configured to advance the frozen product within the storage container; and
a threaded member connected with the push plate such that the push plate is advanced when the threaded member is turned, wherein the threaded member and push plate are configured such that the threaded member is stationary relative to the supply container while the threaded member is being turned.

32. The apparatus of claim 31, further comprising an intermediary driving member comprising a threaded opening to receive the threaded member, wherein the driving member is threadably coupled to the threaded member.

33. The apparatus of claim 31, wherein the threaded member and the push plate are connected such that the push plate is advanced towards a first end of the storage container when the threaded member is turned in a first direction and the push plate is advanced towards a second end of the storage container when the threaded member is turned in a second direction in a second direction, wherein the first end is opposite from the second end and the first direction is opposite from the second direction.
